(19) United States
(12) Patent Application Publication
(10) Pub. No.: US 2016/0190823 A1
(43) Pub. Date: Jun. 30, 2016

(54) OPTIMAL BATTERY CHARGING METHOD AND CIRCUIT

(71) Applicant: ANWELL SEMICONDUCTOR CORP., Hsin-Chu City (TW)

(72) Inventors: SHAO-WEI CHIU, HSIN-CHU CITY (TW); KE-HORNG CHEN, HSINCHU CITY (TW); CHUN-CHIEH KUO, HSIN-CHU CITY (TW); SHIH-PING TU, HSIN-CHU CITY (TW); YU-HSIEN HE, HSIN-CHU CITY (TW); CHENG-PO HSIAO, HSIN-CHU CITY (TW)

(21) Appl. No.: 14/587,207

(22) Filed: Dec. 31, 2014

(51) Int. Cl. H02J 7/00

(52) U.S. Cl. CPC H02J 7/007; H02J 7/0057

(57) ABSTRACT

An optimal battery charging method and circuit for automatically regulating an output current to an energy storage load includes the steps of using a first-status current and a second-status current of the output current to obtain the energy storage load, analyzing the second-status voltage and the first-status voltage to obtain an equivalent resistance parameter of the energy storage load, and using the equivalent resistance parameter to compute a charging power loss of the energy storage load to regulate an output cycle of the output current, so that the energy storage load can be charged at constant temperature to achieve the effect of high charging efficiency.

### BACKGROUND OF THE INVENTION

1. Field of the Invention The present invention relates to the technical field of battery charging equipments, and more particularly to an optimal battery charging method and its circuit capable of maintaining the overall battery charging temperature constant by compensating power loss to enhance the power storage efficiency of the pulse charging technology.

2. Description of the Related Art

Electronic products tend to be developed with a compact size and portable devices become more popular, the demand for battery quality and energy storage efficiency is increased day. after day. At present, the battery charging methods generally include a constant voltage charging method, a constant current charging method, and a pulse charging method, wherein the constant voltage and constant current charging methods come with a simple circuit structure and incur a low cost, and thus they are applied extensively in various types of power supplies, but these two methods have the drawbacks of consuming a very large charging current at an early stage, such that the electrode board of the battery may be damaged by the high temperature of the battery, and taking a very long charging time that is not acceptable by consumers. As to the pulse charging method, it is generally applied to a switched-mode power supply (SMPS), and the circuit of the pulse charging method adopts an inductor switch and a transistor switch as the main structure, so that an intermittent time is provided during the charging process, and the battery uses a larger current for charging, and thus greatly improving the charging efficiency.

For example, a flyback power supply 1 as shown in FIG. 1 comprises a flyback controller 11 and a first optical coupler 12 installed on a primary side of a transformer 10 of the flyback power supply 1, and a charge controller 13 and a second optical coupler 14 installed on a secondary side of the transformer, and the charge controller 13 is provided for checking the instant voltage of the two output terminals connected to the battery, and the second optical coupler 14 feeds the voltage back to the first optical coupler 12 to drive the flyback controller 11 to regulate the duty cycle of the primary-side current of the transformer 10 flexibly to control the pulse duty cycle of the output current of the secondary-side coil. Through the operation of the first optical coupler 12 and the second optical coupler 14, the power supply 1 has the function of outputting current at different stages according to the battery storage status to improve the battery charging efficiency. Although the technology of using the secondary side to feed back the detect signal and controlling the amount of output current by the primary side can improve the charging efficiency and fits the charging requirements of batteries of different specifications, yet the installation of the first optical coupler 12 and the second optical coupler 14 is disadvantageous to the overall size and integration of the circuit. If the voltage change of the output terminal is too large, it is not easy to control the voltage (Vcc) of the power supply of the flyback controller 11, so that the charging efficiency cannot be optimized or improved.

### SUMMARY OF THE INVENTION

In view of the aforementioned problem of the prior art, it is a primary objective of the present invention to improve the secondary-side circuit of the coupling transformer, so that the charging circuit can adjust the amount of output current based on different battery storage statuses, while improving the charging efficiency and reducing the power loss.

To achieve the aforementioned objective, the present invention provides an optimal battery charging method and circuit that controls the amount of current for charging a battery by detecting the equivalent resistance parameter of the battery in advance, so as to achieve the effects of high charging efficiency and maximized power utility.

To achieve the aforementioned objective, the present invention provides an optimal battery charging method for automatically regulating the amount of an output current to optimize the charging efficiency of an energy storage load, comprising the steps of:

inputting a first-status current of the output current to the energy storage load to obtain a first-status voltage; inputting a second-status current of the output current to the energy storage load to obtain a second-status voltage; analyzing the second-status voltage and the first-status voltage to obtain an equivalent resistance parameter of the energy storage load; and using the equivalent resistance parameter to compute a charging power loss of the energy storage load to regulate the output cycle of the output current, so as to charge the energy storage load in a constant temperature status.

Wherein, the first status of the output current is a zero-ampere current, and the first-status voltage is an idle voltage of the energy storage load, or the first status and second status of the output current are a first cycle and a second cycle being a pulse current respectively.

The optimal battery charging method further comprises the step of using a filtering method to analyze the second-status voltage and the first-status voltage to obtain an equivalent resistance parameter of the energy storage load. In another preferred embodiment, the optimal battery charging method uses a thermistor and a current source to compensate the charging power loss to regulate the output cycle of the output current.

To achieve the aforementioned objective, the present invention further provides an optimal battery charging circuit for automatically regulating the amount of an output current to optimize the charging efficiency of an energy storage load, characterized in that the optimal battery charging circuit comprises a switch module and a filter module, and the switch module is electrically coupled to the filter module and the energy storage load and controls an output cycle of the output current; when the output current is outputted through the switch module to the energy storage load to form a first-status voltage and a second-status voltage, the filter module analyzes the second-status voltage and the first-status voltage to obtain an equivalent resistance parameter of the energy storage load, and the optimal battery charging circuit uses the equivalent resistance parameter to compute a charging power loss of the energy storage load to regulate a duty cycle of the switch module, so that the energy storage load can be charged in a constant temperature status.

Wherein, the first-status voltage is an idle voltage of the energy storage load, or the output current is a pulse current, so that the energy storage load receives a first cycle of the pulse current to form the first-status voltage and receives a second cycle of the pulse current to form the second-status voltage.

The optimal battery charging circuit further comprises a feedback module and a multiplier, wherein the feedback module is electrically coupled to the switch module, the energy storage load, and the multiplier, and the multiplier is electrically coupled to the filter module; and after the feedback module feeds back the output current to form a feedback current, the multiplier uses the equivalent resistance parameter and the feedback current to compute a charging power loss of the energy storage load. In addition, the optimal battery charging circuit further comprises a thermistor and a current source, and the thermistor is installed at a side of the energy storage load to sense an instant temperature of the energy storage load and then change an resistance value of the energy storage load, and the charging power loss is compensated after multiplying the resistance value with a reference current supplied by the current source.

In summation, the present invention adopts a power compensation method to charge an energy storage load in a constant temperature to prevent the energy storage load from being affected by the heat of internal resistance and consuming unnecessary energy, so as to overcome the issues of lowering the energy storage efficiency and shortening the overall service life of the battery.

### BRIEF DESCRIPTION OF THE DRAWINGS

FIG. 1 is a schematic circuit diagram of a conventional flyback power supply;

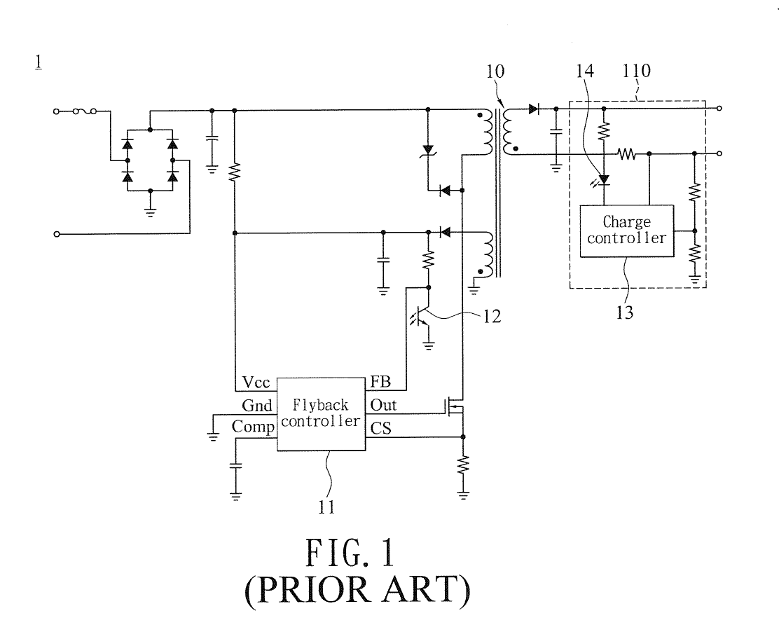

FIG. 2 is a schematic block diagram of a preferred embodiment of the present invention;

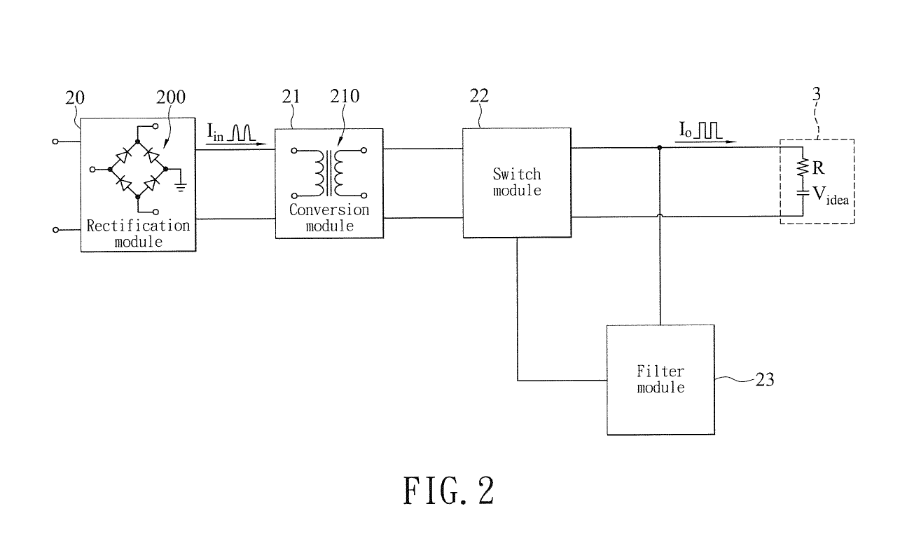

FIG. 3 is a flow chart of a first implementation mode of a preferred embodiment of the present invention;

FIG. 4 is a flow chart of a second implementation mode of a preferred embodiment of the present invention;

FIG. 5 is a schematic block diagram of the second implementation mode of a preferred embodiment of the present invention;

FIG. 6 is a schematic circuit diagram of the second implementation mode of a preferred embodiment of the present invention;

FIG. 7 is a waveform diagram of the second implementation mode of a preferred embodiment of the present invention.

### DETAILED DESCRIPTION OF THE PREFERRED EMBODIMENTS

The aforementioned and other objectives, technical characteristics and advantages of the present invention will become apparent with the detailed description of preferred embodiments and the illustration of related drawings as follows.

With reference to FIG, 2 for a schematic block diagram of a preferred embodiment of the present invention, an optimal battery charging circuit 2 for automatically regulating the amount of an output current (Io) to charge an energy storage load 3 at constant temperature to optimize the charging efficiency comprises a rectification module 20, a conversion module 21, a switch module 22 and a filter module 23, wherein the conversion module 21 includes a coupling transformer 210 installed therein and electrically coupled to the rectification module 20 and the switch module 22, and the switch module 22 is electrically coupled to the filter module 23 and the energy storage load 3 and provided for controlling the output cycle of the output current. T he rectification module 20 includes an electromagnetic interference (EMI) element (not shown in the figure) and abridge rectifier 200, and a terminal of the bridge rectifier 200 is electrically coupled to an AC power (not shown in the figure) through the EMI element for receiving an alternate current (AC), and the other terminal of the bridge rectifier 200 is electrically coupled to the conversion module 21 for rectifying the alternate current (AC) to form and output an input current (Iin) to the conversion module 21, and the conversion module 21 uses a built-in coupling transformer 210 to receive and sense the input current to form the output current (Io).

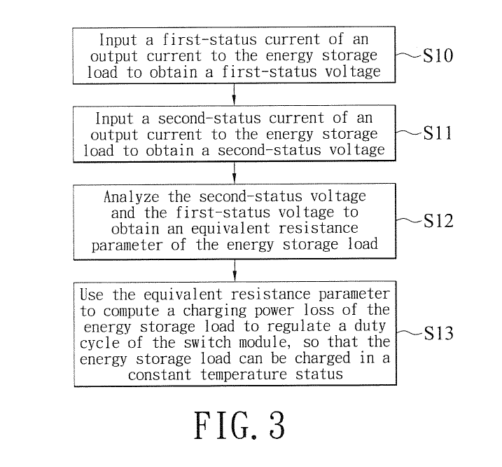

In a preferred embodiment, when the battery charging circuit 2 carries the energy storage load 3 and connects the AC power to start its operation, the operation as shown in FIG. 3 comprises the following steps:

S10: The battery charging circuit 2 outputs the output current to the energy storage load 3 through the switch module 22, and uses a first-status current such as a zero-ampere current of the output current to obtain a first-status voltage of the energy storage load 3 by the filter module 23, wherein the first-status current is the originally idle voltage (Videa) of the energy storage load 3.

S11: The battery charging circuit 2 outputs a second-status current (Ich) of the output current to the energy storage load 3 to charge the energy storage load 3, so that the filter module 23 obtains a second-status voltage (Vb) which is affected by the resistance (R) of the energy storage load 3. and Vb=Ich×R+Videa.

S12: The filter module 23 analyzes the second-status voltage (Vb) and the first-status voltage (Videa) to obtain an equivalent resistance parameter (R) of the energy storage load 3.

S13: The battery charging circuit 2 uses the equivalent resistance parameter to compute a charging power loss of the energy storage load 3 to regulate a duty cycle of the switch module 22, so that the energy storage load 3 can be charged in a constant temperature status.

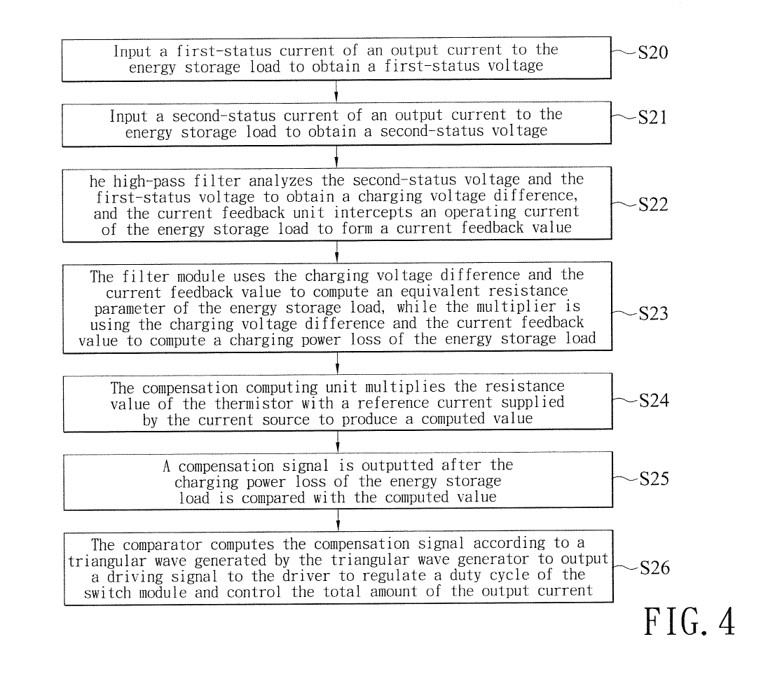

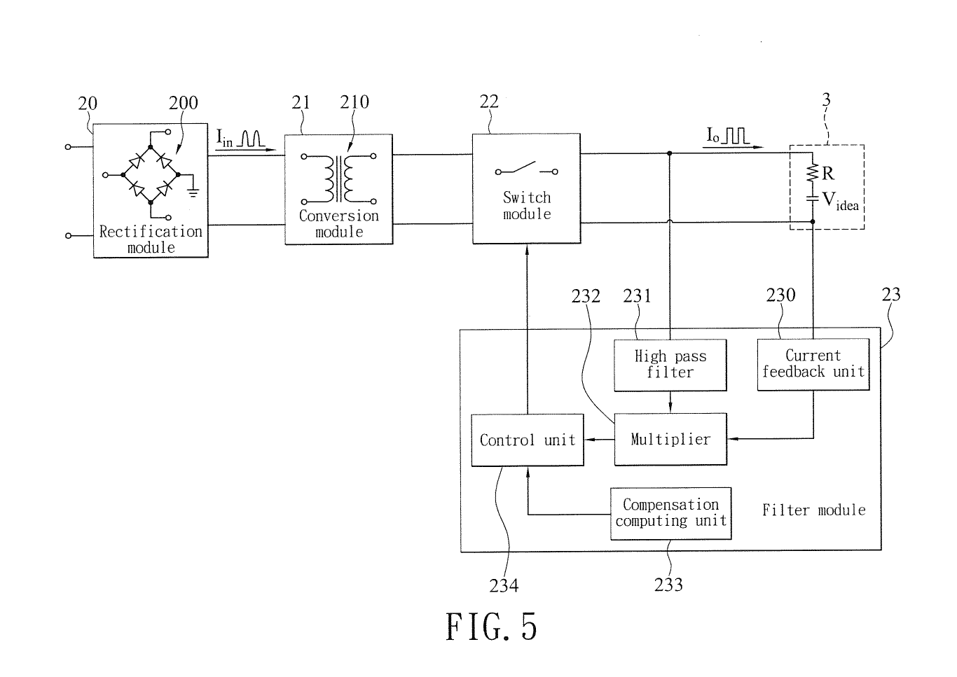

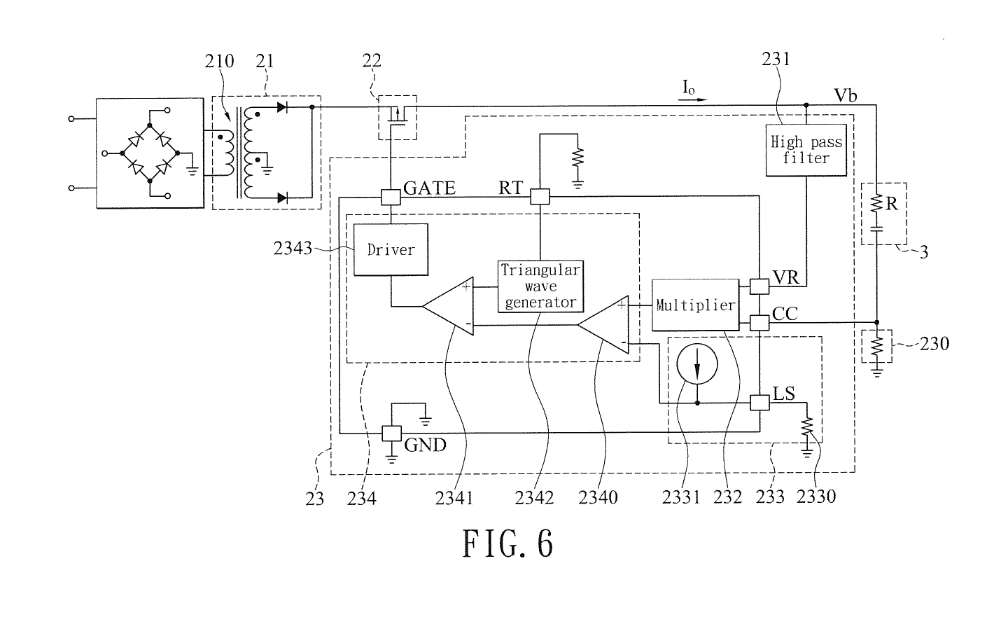

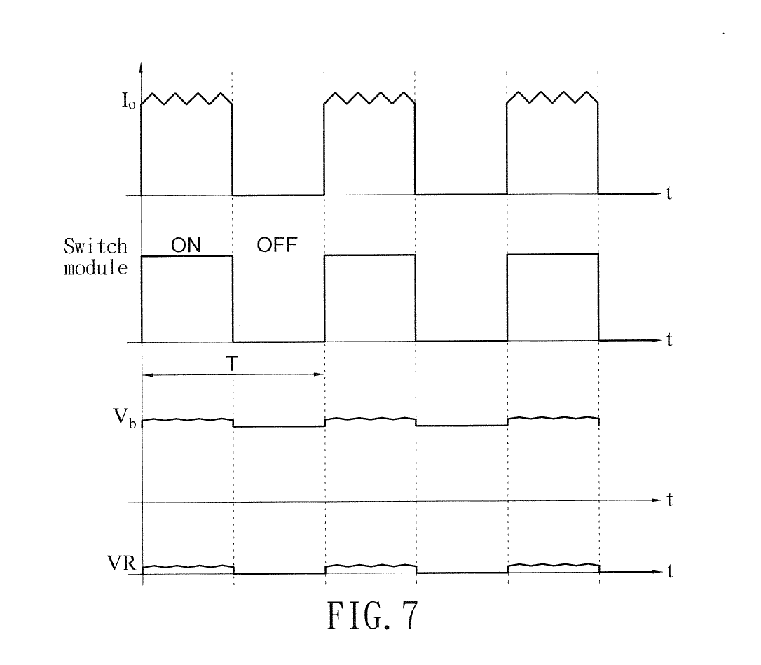

With reference to FIGS. 4 to 7 for another preferred embodiment of the present invention, the switch module 22 is a transistor, and the filter module 23 includes a current feedback unit 230, a high-pass filter 231, a multiplier 232, a compensation computing unit 233 and a control unit 234, wherein the compensation computing unit 233 is comprised of a thermistor 2330 and a current source 2331, and the control unit 234 includes an error amplifier 2340, a comparator 2341, a triangular wave generator 2342 and a driver 2343. T he current feedback unit 230 is electrically coupled to the energy storage load 3 and an input terminal of the multiplier 232, and the high-pass filter 231 is electrically coupled to a drain of the transistor, an input terminal of the multiplier 232 and the energy storage load 3, and output terminal of the multiplier 232 is coupled to a positive input terminal of the error amplifier 2340. A negative input terminal of the multiplier is coupled to the current source 2331 and the thermistor 2330, and an output terminal of the multiplier is coupled to a negative input terminal of the comparator 2341, and a positive input terminal of the comparator 2341 is coupled to the triangular wave generator 2342 for receiving a triangular wave, and an output terminal of the comparator 2341 is electrically coupled to a gate of the transistor through the driver 2343, and a source of the transistor is coupled to a secondary-side coil of the coupling transformer 210.

When the battery charging circuit 2 starts its operation, the switch module 22 receives and outputs the output current (lo) supplied by the coupling transformer 210 to the energy storage load 3 in a duty cycle to charge the energy storage load 3.

S20: The filter module 23 uses a first-status current of the output current such as a first cycle of a pulse current to obtain a first-status voltage of the energy storage load 3 by the high-pass filter 231.

S21: The switch module 22 outputs a second-status current of the output current such as a second cycle of the pulse current to the energy storage load 3 to charge the energy storage load 3, so that the high-pass filter 231 obtains a second-status voltage (Vb).

S22: The high-pass filter 231 analyzes the second-status voltage and the first-status voltage to obtain a charging voltage difference (VR), and the current feedback unit 230 intercepts an operating current of the energy storage load 3 to form a current feedback value.

S23: The filter module 23 uses the charging voltage difference and the current feedback value to compute an equivalent resistance parameter (R) of the energy storage load 3, while the multiplier 232 is using the charging voltage difference and the current feedback value to compute a charging power loss of the energy storage load 3.

S24: The compensation computing unit 233 multiplies the resistance value of the thermistor 2330 with a reference current supplied by the current source 2331 to produce a computed value which is sent to the error amplifier 2340.

S25: A compensation signal is outputted after the charging power loss of the energy storage load 3 is compared with the computed value.

S26: The comparator 2341 computes the compensation signal according to a triangular wave generated by the triangular wave generator 2342 to output a driving signal to the driver 2343 to regulate a duty cycle of the switch module 22 and control the total amount of the output current. In this implementation mode, the thermistor 2330 is installed at a side of the energy storage load 3 to sense an instant temperature of the energy storage load 3 and then changes its resistance value. If the equivalent resistance of the energy storage load 3 is increased with the charging time, the resistance value of the thermistor 2330 will be dropped to decrease the computed value accordingly, so that the voltage level of the compensation signal will rise to shorten the duty cycle of the driving signal. In other words, the conduction cycle of the transistor is shortened to decrease the amount of the output current to compensate the charging power loss and drop the temperature of the energy storage load 3 back to a predetermined value, so as to maintain charging the energy storage load 3 in a constant temperature status and optimize the charging efficiency.

What is claimed is:

1. An optimal battery charging method, for automatically regulating the amount of an output current to optimize the charging efficiency of an energy storage load, comprising the steps of:
inputting a first-status current of the output current to the energy storage load to obtain a first-status voltage;
inputting a second-status current of the output current to the energy storage load to obtain a second-status voltage;
analyzing the second-status voltage and the first-status voltage to obtain an equivalent resistance parameter of the energy storage load; and
using the equivalent resistance parameter to compute a charging power loss of the energy storage load to regulate an output cycle of the output current, so as to charge the energy storage load at constant temperature.

2. The optimal battery charging method of claim 1, wherein the first status of the output current is a zero-ampere current, and the first-status voltage is an idle voltage of the energy storage load.

3. The optimal battery charging method of claim 1, wherein the first status and second status of the output current are a first cycle and a second cycle of a pulse current respectively.

4. The optimal battery charging method of claim 3, further comprising the step of using a filtering method to analyze the second-status voltage and the first-status voltage to obtain an equivalent resistance parameter of the energy storage load.

5. The optimal battery charging method of claim 2, further comprising the step of using a thermistor and a current source to compensate the charging power loss to regulate the output cycle of the output current.

6. The optimal battery charging method of claim 4, further comprising the step of using a thermistor and a current source to compensate the charging power loss to regulate the output cycle of the output current.

7. An optimal battery charging circuit, for automatically regulating the amount of an output current to optimize the charging efficiency of an energy storage load, characterized in that the optimal battery charging circuit comprises a switch module and a filter module, and the switch module is electrically coupled to the filter module and the energy storage load and controls an output cycle of the output current; when the output current is outputted through the switch module to the energy storage load to form a first-status voltage and a second-status voltage, the filter module analyzes the second-status voltage and the first-status voltage to obtain an equivalent resistance parameter of the energy storage load, and the optimal battery charging circuit uses the equivalent resistance parameter to compute a charging power loss of the energy storage load to regulate a duty cycle of the switch module, so that the energy storage load can be charged in a constant temperature status.

8. The optimal battery charging circuit of claim 7, wherein the first-status voltage is an idle voltage of the energy storage load.

9. The optimal battery charging circuit of claim 7, wherein the output current is a pulse current, so that the energy storage load receives a first cycle of the pulse current to form the first-status voltage and receives a second cycle of the pulse current to form the second-status voltage.

10. The optimal battery charging circuit of claim 9, wherein the filter module comprises a high-pass filter, a current feedback unit, and a multiplier, the high-pass filter is electrically coupled to the switch module, the energy storage load and the multiplier, and the current feedback unit is electrically coupled to the energy storage load and the multiplier, and the high-pass filter analyzes the second-status voltage and the first-status voltage to obtain a charging voltage difference, and the current feedback unit feeds back an operating current o f the energy storage load to form a current feedback value, and then the multiplier uses the charging voltage difference and the current feedback value to compute a charging power loss of the energy storage load.

11. The optimal battery charging circuit of claim 10, further comprising a thermistor and a current source, and the thermistor is installed at a side of the energy storage load to sense an instant temperature of the energy storage load and then change an resistance value of the energy storage load, and the charging power loss is compensated after multiplying the resistance value with a reference current supplied by the current source.
